(19) United States
(12) Patent Application Publication
(10) Pub. No.: US 2019/0020730 A1
(43) Pub. Date: Jan. 17, 2019

(54) METHOD OF TRANSFERRING SOFTWARE FILES IN A SHORT RANGE WIRELESS NETWORK

(71) Applicants: Suresh Kumar Singamsetty, Aliso Viejo, CA (US); Dennis Ching Chung Kwan, San Diego, CA (US)

(72) Inventors: Suresh Kumar Singamsetty, Aliso Viejo, CA (US); Dennis Ching Chung Kwan, San Diego, CA (US)

(21) Appl. No.: 14/887,296

(22) Filed: Oct. 19, 2015

Related U.S. Application Data
(60) Provisional application No. 62/087,161, filed on Dec. 3, 2014.
(60) Provisional application No. 62/131,843, filed on Mar. 12, 2015.

(51) Int. Cl. H04L 29/08; H04W 4/80

(52) U.S. Cl. CPC H04L 67/34; H04W 84/18; H04W 4/80

(57) ABSTRACT

The present invention proposes a system for facilitating transmission of software files from the originating node to at least one target node by short range wireless communication link. The system comprises plurality of nodes, a bridge, an originating node and a target node wherein each node is enabled to trans-receive the data using short range communication link.

### CROSS-REFERENCE TO RELATED APPLICATIONS

This present disclosure claims the benefit of U.S. Provisional Application Ser. No. 62/087,161, filed on Dec. 3, 2014 and Ser. No. 62/131,843, filed on Mar. 12, 2015.

### TECHNICAL FIELD

The present invention is related to the transmission of software files to a particular node in a short-range wireless network. Specifically the present invention is related to transmission of software or firmware updates to a particular node in a wireless mesh network.

### BRIEF BACKGROUND

Modern day computing devices are fundamentally controlled by executable software or embedded firmware. Naturally, manufacturers of such devices often find it necessary to ensure that their products have the latest versions of software or firmware installed. However, the manufacturer may find it difficult to update the firmware once the computing device is sold to a user. Typically, this is remedied by having the user of a device download an update and then install said update on said device. This process may work for some use cases however it can get cumbersome as the number of devices increases (e.g. IoT applications).

Some manufacturers have attempted to solve this problem by having computing devices periodically go online and look for updates. If an update is available the computing device may be programmed to automatically download the update and install the software. Unfortunately this method does not scale well (i.e. when there a lot of devices present) since it requires each device to have a reliable and secure connection to the internet. Another approach is for the manufacturer to push updates to each device. This method is not without scaling limitation since the manufacturer may fail to reliably send the updates to every computing device due to interruptions in the communication link, a weak communication link, a remote location of the device, a connection timeout and many other factors related to the communication link. This naturally results in bad user experience and hence may develop a negative reputation against the manufacturer.

Thus there is a current and impending need for a method for reliably sending software to an electronic device that can scale as the number of devices grows.

### SUMMARY OF THE INVENTION

The present invention proposes a system for facilitating transmission of software files from an originating node to at least one target node by short-range wireless communication link. The system may comprise of a plurality of nodes, a bridge, an originating node and a target node. It is valuable to understand that there could be plurality of target nodes as well. Each node is enabled to trans-receive the data using short-range communication link.

In one embodiment, at least one node amongst the plurality of nodes is connected to a bridge, which enables the originating node to transmit the data packet in a situation when the target node is situated outside the short communication network.

In another embodiment of the present invention, the third party server is enabled to send software files to the third party device through similar manner. The third party server initiates the advertising packet and transmits it to the corresponding bridge. Thereafter, the bridge retransmits the advertising packet in the short range wireless network to reach to the third party device.

In yet another embodiment of the invention in which the third party server is present within the short-range wireless network, the bridge is not connected with any node in this embodiment and therefore the advertising packet remains within the short-range wireless network.

### BRIEF DESCRIPTION OF THE FIGURES

The invention is more fully appreciated in connection with the following detailed description taken in conjunction with the accompanying drawings, in which:

FIG. 1 illustrates a flow chart of a system for facilitating transmission of software files from the originating node 100 to at least one target node 108, wherein the target node 108 is in a different network than the originating node 100.

FIG. 2 illustrates a flow chart of a system for facilitating transmission of software files from the originating node 100 to at least one target node 108, wherein the target node 108 is in a same network than the originating node 100.

FIG. 3 illustrates transmission of the advertising packet 302 from originating node 300 to the plurality of proximal nodes N1, N2 and N3 to reach to the target node N4.

FIG. 4 illustrates the advertising packet 400, 402, 404 transmitting from the target node N4 to the originating node 300 through plurality of nodes N1, N2 and N3.

FIG. 5 illustrates the data packet transmitting 500 from the originating node 300 to the target node N4 via favorable route N1-N3-N4.

FIG. 6A illustrates an advertising packet transmitted from the originating node 300 to the target node N4.

FIG. 6B illustrates 16 byte encrypted data present in the advertising packet transmitted from the originating node 300 to the target node N4.

FIG. 7 is a flowchart 700 depicting the Generic Attribute Profile (Gatt) services and characteristics are used for the implementation of the store and push architecture.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

As used herein, the term ‘short range communication link and shod range communication network refers to at least one of a Bluetooth network (including networks that comply with the Bluetooth Low Energy [BLE] standard), near field communication network, ANT network, infrared communication network, WIBREE network, Zigbee network, Ultra-Wideband communication network, or any communication network implementing an Institute of Electrical and Electronics Engineers 802.15 standard. Moreover, the originating node is referred to as third party device and target node is referred to as third party server.

### Network Bridge and Message Propagation

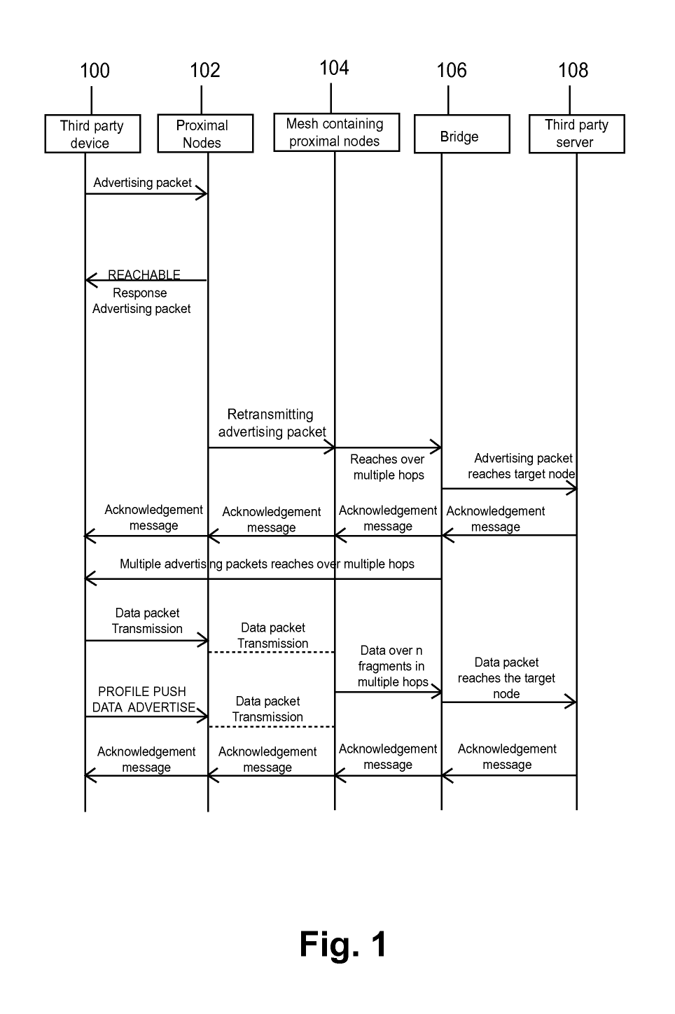

FIG. 1 illustrates a flow chart of the present invention and preferred embodiment of the invention. The third party device 100 intends to transmit the software files to the third par server 108 wherein the third party server 108 is located outside the short-range wireless communication network. Initially, the third party device 100 transmits the advertising packet to the proximal nodes 102 wherein the advertising packet contains the network ID of the third party server 108 in a short-range wireless network. The proximal node 102 compares its network ID with the network ID present in the advertising packet. Once the node determines that network ID does not match with the network ID present in the advertising packet, it transmits the received advertising packet in short-range wireless network mesh consisting of plurality of nodes 104. Retransmission of advertising packet will continue till it reaches the at least one node 104 connected with a bridge 106 wherein the bridge 106 enables the advertising packet to travel to another network or outside the short range wireless network. The bridge 106 may be an internet enabled bridge, a short range wireless range communication enabled bridge, a LAN enabled bridge or a WLAN enabled bridge. The bridge 106 enables the advertising packet to travel through and reach to the third party server 108 connected with the different network.

The third party server 108 acknowledges the advertising packet and retransmits back to the third party device 100 through same nodes 102, 104 from which it receives the advertising packet. Thereafter, the third party device 100 computes the favorable route to reach to the third party server 108. The favorable route comprises the preferred nodes in a short-range wireless communication mesh through which the data packet is to be transmitted to reach to the third party server 108. Once the favorable route is determined, the third party device 100 transmits the data packet, containing the first batch of software files along with route information, to the third party server 108. As soon as the data packet reaches any node during its travel, each node determines the validity of the cyclic redundancy check (CRC) and software files in the data packet. Once the validation is successful, the corresponding node 102, 104 transmits an acknowledgement signal back to the third party device 100 and retransmits the advertising packet to its next destination node 104. Once the third party server 108 receives the data packet, it will perform the validity of CRC and software files. Once the validation is successful, the third party server 108 transmits the acknowledgement signal back to the third party device 100.

Thereafter, the third party server 108 store and install the batch of software files in its memory. Also, thereafter, the third party server transmits the acknowledgement message to the third party device 100 through the favorable route containing a message that the corresponding batch of the software files has been installed successfully. However, if the CRC check is failed or installation of the software files fails then the unsuccessful message is transmitted back to the third party device 100 through the favorable route. Moreover, once the acknowledgment message is received by the third party device 100 only then does it transmit the subsequent data packet containing the next batch of software files. However, if the third party device receives the unsuccessful message from the third party server 108 then it retransmits the previously sent data packet to the third party server 108. This process will repeat until all batch files are successfully installed by the third party server 108.

In another embodiment of the present invention, the third party server 108 is enabled to send the software files to the third party device 100 through similar manner. The third party server 108 initiates the advertising packet and transmits it to the corresponding bridge 106. Thereafter, the bridge 106 retransmits the advertising packet in the short-range wireless network to reach to the third party device 100.

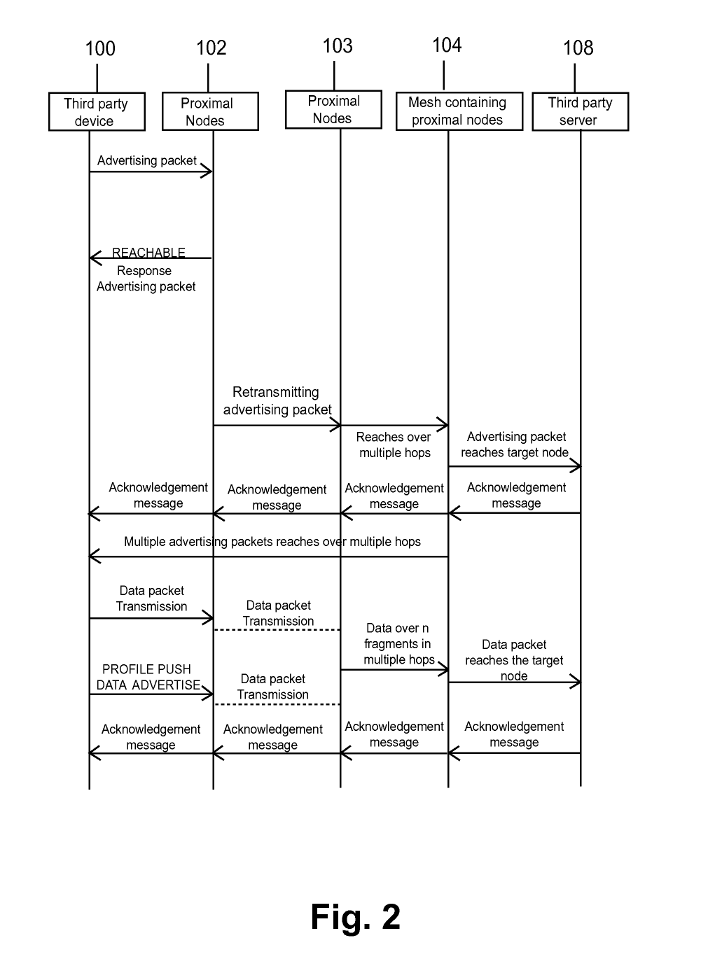

FIG. 2 illustrates yet another embodiment of the invention in which the third party server 108 is present within the short-range wireless network. The bridge is not connected with any node in this embodiment and therefore the advertising packet remains within the short-range wireless network. Otherwise, in this embodiment, the message propagation will remain the same as the example in FIG. 1.

### Node Discovery and Message Routing

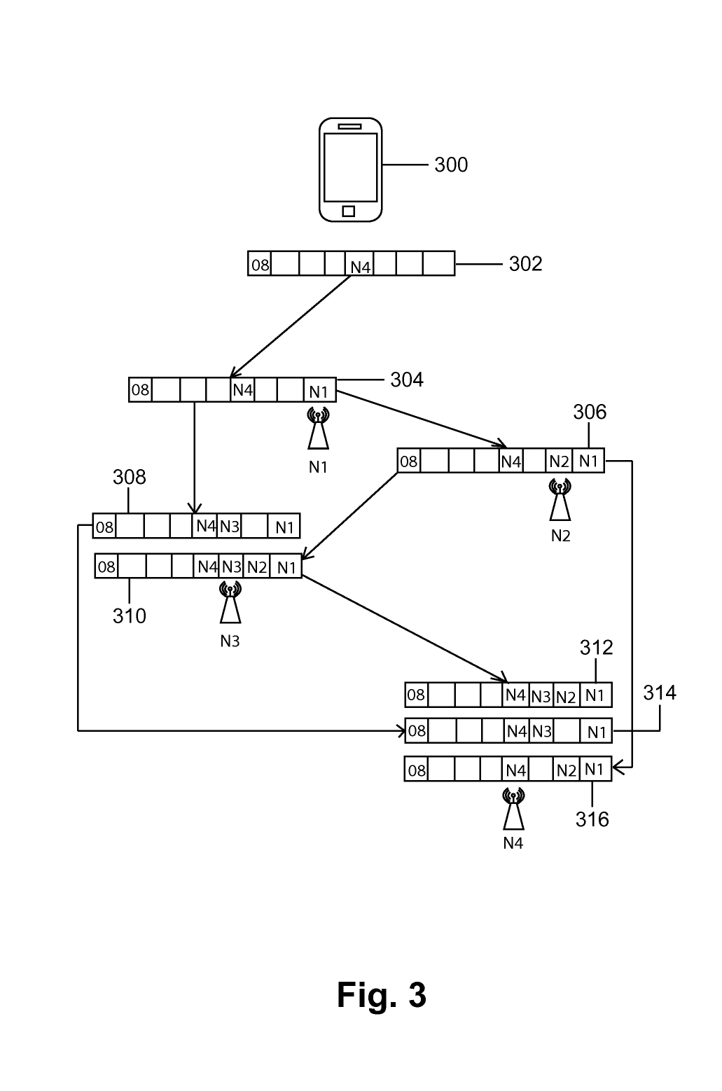

FIG. 3 illustrates the advertising packet flow from the third party device 300 to the target node ‘N4’. The figure illustrates that the third party device 300 intends to transmit the advertising packet 302 to the node N4 and hence inputs the network ID as N4 and type as 08 wherein the 08 type indicates that the advertising packet 302 has not reached the target node N4 as yet. Thereafter, it is transmitted from the third party device 300 and reaches the first proximal node N1. Node N1 compares its network ID with the network ID present in the advertising packet 304. The node identifies that the N1 does not matches with the N4 and then retransmits it to the further proximal nodes. Nodes N2 and N3 receive the advertising packet 306, 308 respectively from the node N1 and perform the comparison of their respective network IDs with the network ID present in the advertising packet 306, 308 respectively. Once the node N2 and N3 determines the mismatch of the network IDs, both nodes N2 and N3 retransmits the advertising packet 306, 308 respectively to the further proximal nodes. The node N3 receives the advertising packet 310 from the node N2 and performs a comparison analysis of the network ID. The node N3 further retransmits the advertising packet 310 to the proximal nodes once it determines that the advertising packet 310 received from the node N2 does not contains the network ID of node N3. The node N4 receives both the advertising packet 312, 314 received from the node N3 and the advertising packet 316 from node N2.

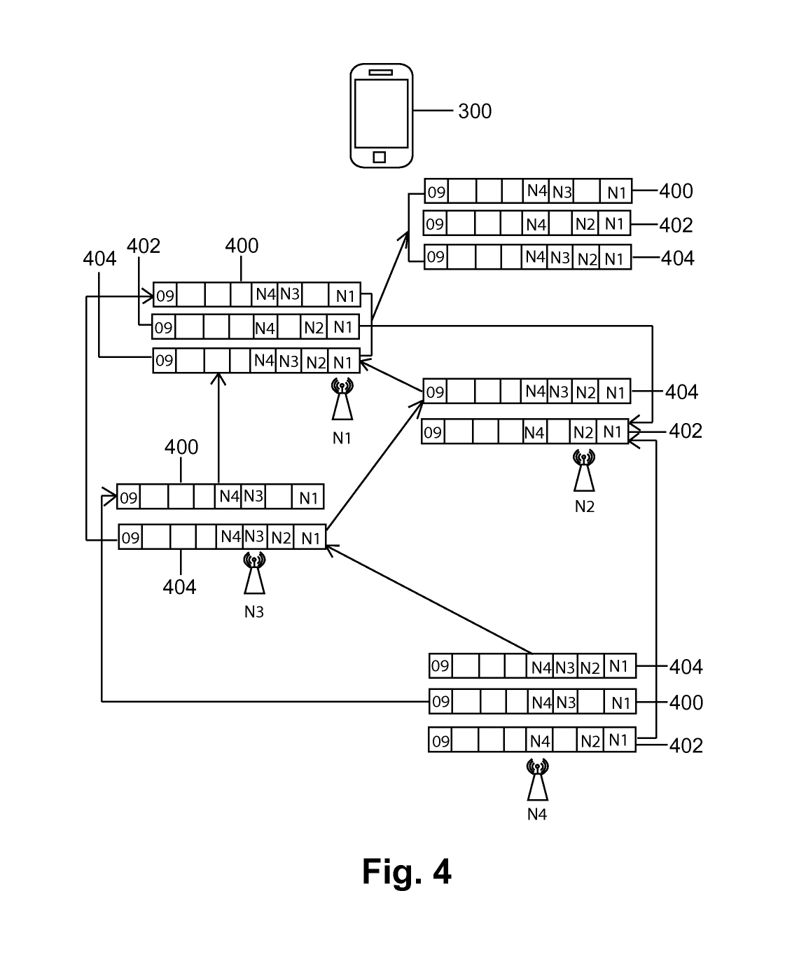

FIG. 4 illustrates the retransmission of advertising packets 400, 402, 404 from the node N4 back to the third party device 300. The node N4 compares its network ID with the network ID present in the advertising packet and once the match of network IDs is confirmed then the node N4 changes the type 09 from 08 and retransmits it back to the third party device through same nodes N1, N2 & N3 from which it received the advertising packet 400, 402, 404. Two of three advertising packets 400, 404 of node N4 are transmitted to Node N3 from node N4 and one advertising packet 402 to N2. Similarly, the advertising packet is traveled back to the third party device 300 where the third party device receives the three advertising packets 400, 402, 404. Thereafter the computing unit determines the most favorable route to reach to the target node N4 from the three advertising packet received from the proximal node N1.

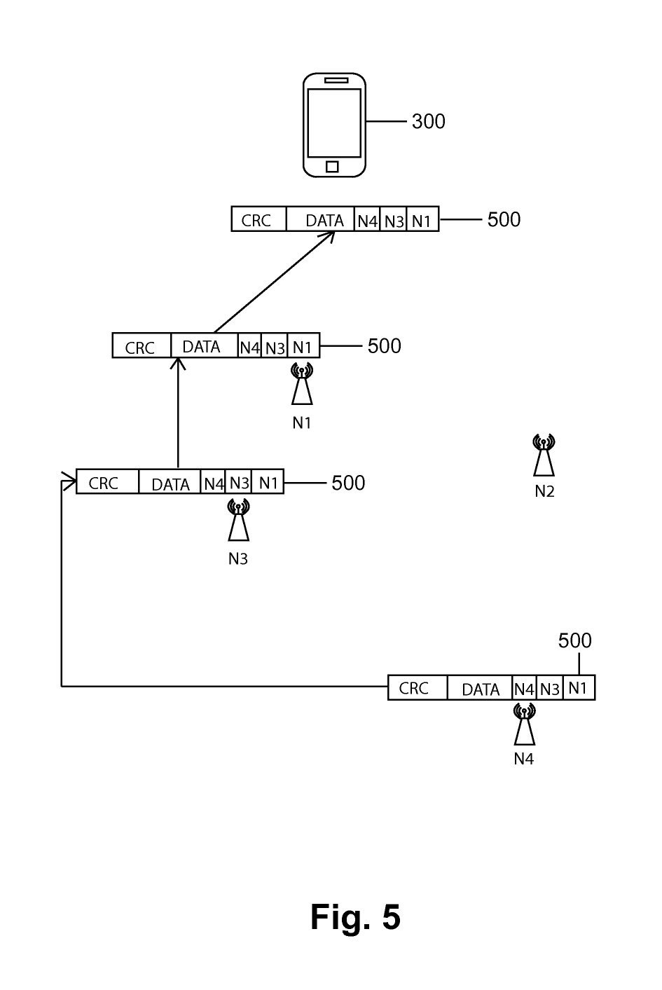

FIG. 5 illustrates the transmission of data packet 500 from the third party device 300 to the target node N4. The data packet 500, containing one batch of software files, CRC and route information, is transmitted from third party device 300 to first node N1 of the route wherein the node N1 validates the CRC and batch of software files after receiving the data packet 500. Once the validation is found successful, the node N1 transmits an acknowledgement message back to the third party device 300 and retransmits the data packet 500 to the next destination node N3. The node N3 also validates the CRC and batch of software files and once the validation is found successful, the node N3 transmits the acknowledgement signal back to the third party device 300 and further retransmits the data packet 500 to the target node N4. The node N4 again validates the CRC and batch of software files and once validation is found successful, the node N4 transmit the acknowledgement message to third party device 300 and further stores and install the batch of software files in its memory. This process continues till the all batches of software files are stored and installed in the target node N4. It is exemplary to mention that the memory of the target node N4 is removable memory, flash memory, EEPROM. It is also exemplary to mention that the software files are at least one of dynamic link library files, shared object files, embedded software components, firmware files, executable files, data files, hex data files, system configuration files, and personal data files.

### Advertisement Packet

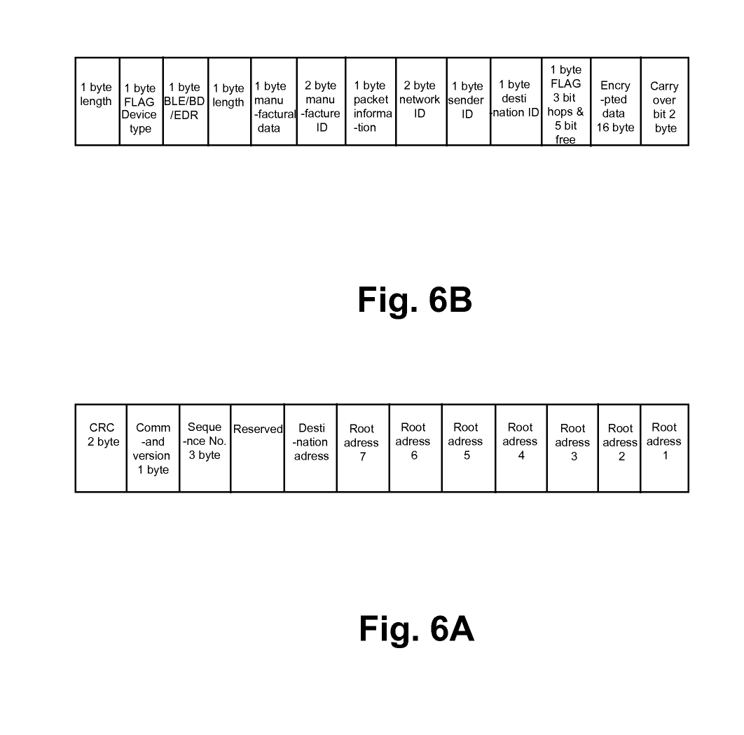

FIG. 6A illustrates a typical advertising packet which is transmitted by the third party device. Wherein the attributes of the advertising packet illustrates the following:

1 Byte length: Specifies the length of the data that follows.
1 Byte Flag: Indicates the type of data that follows.
1 Byte BD/EBR/BLE: This 1 byte filed indicates the type of device which is sending the packet.
Manufacture Specific data: This is a flag which indicates the data that is going to follow the Manufacture Specific data of the node
Manufacture ID: This field contains the Manufacture ID of the node.
Network ID: It indicates the network ID of the target node.
Sender ID: Is the node address of the retransmitting node.
Destination ID: Is the address of the node which needs to update with the latest firmware.
Hops and Flags: This contains the Hop count and the carryover of the encryption,
Encrypted Data: This field contains the payload to be transferred/updated in the encrypted form and the CRC and version.
Carry over Bits: This 2 byte field contains the carry over bits of the encryption.

FIG. 6B illustrates the 16 byte encrypted data of the advertising packet, wherein the attributes of the 16 byte encrypted data is following:

2 Byte CRC—Is used to check the validate the data area after AES encryption
1 Byte command version—is used by the third party device to give the command to the receiving node.
3 Byte Sequence no—is used to avoid duplication of messages
Destination address—represents the destination id of the target node.
Route address 1-7: represents the route that advertising packet travels through before reaching the target node.

### Store and Push Mechanism

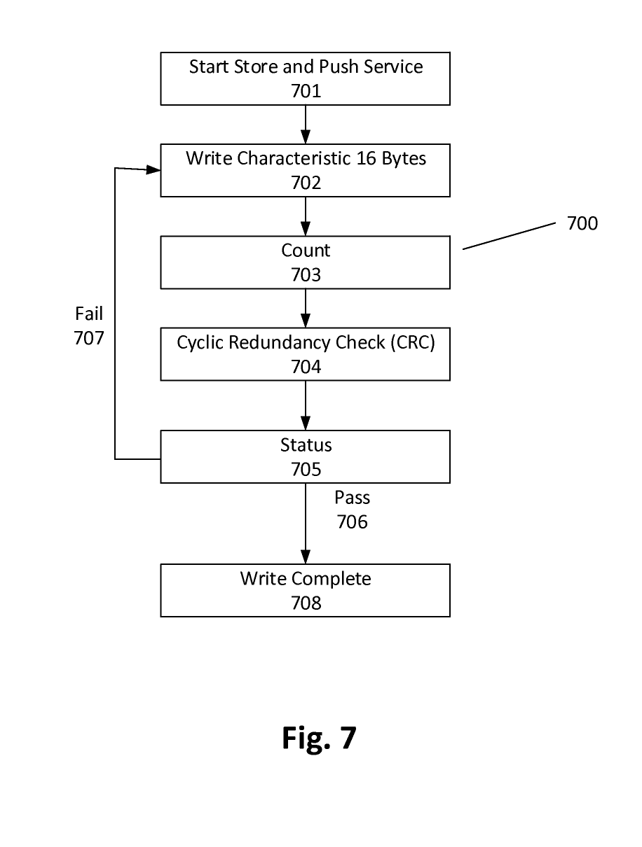

In one embodiment the mechanism for storing and pushing software and firmware to the nodes is implemented with the BLE connected mode data transfer. FIG. 7 is a flowchart 700 depicting the Generic Attribute Profile (Gatt) services and characteristics that are used for the implementation of the store and push architecture of the present invention.

After the mesh route discovery the mobile application will have the route information to the node that needs to be updated. The mobile device (originating node) will then scan for the advertisements and connect to the first node (target node) on to which it needs to transfer the data.

Once the application establishes the connection with the target node the originating node initiates the Store and Push Service 701. Next, the originating node starts transferring data to the target node with a predefined block size 702. Within the first 16 bytes that are written to the target node—in every block transfer—there will be the 3-byte session ID followed by the route information and then the actual data. Once the block transfer is complete the application counts the number of blocks it has written 703. Next the CRC is performed 704 and the status is reported back from the originating node to determine if the transfer was successful 705. The originating node in turn will check the status and will verify the CRC 705. If the CRC of the block matches then the status of the transfer is a success 706 else, a fail 707. If there is a failure case the application needs to rewrite the data again 702. If it's a success the application writes to the write complete characteristics and disconnects the connection 708. The disconnection could also be initiated by the node device once the write complete write on the characteristics happens.

The node which has the block data now checks for the next node address it needs to transfer the data, listens to the advertisements it's receiving to find the node which it needs to write the data.

Once the proper node is found it established the connection and does the same operation which was done by the application. This process continues till the desired node is reached. Once the desired node is reached the node writes the data to the EEPROM and sends an acknowledgement to the mobile application with the same transaction ID with BLE Advertisement. This continues till the firmware update is completed.

Once the firmware update is completed the mobile application sends an update request to the device and device reboots with the updated firmware

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A method of transferring at least one software file to at least one target node in a short range wireless network, the method comprising the steps of:
Transmitting at least one advertising packet from an originating node, using a short range wireless communication link, to plurality of nodes of short range wireless network, situated in proximal range of the originating node, wherein the advertising packet comprises a network ID of the target node;
Retransmitting the received advertising packet, using the short range wireless communication link, by the receiving node to either plurality of nodes, situated in proximal range to the receiving node, when the network ID of the target node, present in the advertising packet, does not matches with the network ID of the receiving node or back to the originating node via same route of nodes through which the advertising packet reaches the target node from the originating node, of the short range wireless network, when the network ID of the target node, present in the advertising packet, matches with the network ID of the receiving node, wherein the advertising packet received from the target node by the originating node comprises the network ID of each node, of the short range wireless network, through which the advertising packet reaches the target node from the originating node;
Computing a favorable route by the originating node, involving at least one node of the short range wireless network, to reach to the target node from the originating node, in order to transmit at least one data packet to the target node, wherein the data packet comprises the route information, in the short range wireless network, to reach to the target node and at least one software file of the target node; and
Transmitting at least one data packet to the target node from the originating node, in accordance with route information present in the data packet, wherein the target node extract the electronic files from the received data packet and perform at least one of store and install the extracted electronic files in a memory unit of the target node.

2. The method of claim 1, wherein the short range wireless communication network and short range wireless communication link is at least one of a Bluetooth network, near field communication network, ANT network, infrared communication network, WIBREE network, Zigbee network, Ultra-Wideband communication network, or any communication network implementing an Institute of Electrical and Electronics Engineers 802.15 standard.

3. The method of claim 1, wherein the software file is at least one of dynamic link library files, shared object files, embedded software components, firmware files, executable files, data files, hex data files, system configuration files, and personal data files.

4. The method of claim 1, wherein the originating node is at least one of a computer application, mobile application, a tablet application or a wearable device application.

5. The method of claim 1, wherein the target node is at least one of an illumination device, a medical device, a wearable device, a tablet, server, a computer, a laptop or a home appliance device.

6. The method of claim 1, wherein the favorable route is the shortest distance route to reach to the target node from the originating node.

7. The method of claim 1, wherein the target node transmits the acknowledgement signal to the originating node after receiving the data packet.

8. The method of claim 1, wherein the memory unit of the target node is at least one of EEPROM, Flash memory, or an external memory.

9. The method of claim 1, wherein the at least one node, of short range network, is connected to the bridge which enables the inter-network communication between the originating node and the target node, wherein the bridge is at least one of internet enabled bridge, WIFI enabled bridge, LAN enabled bridge, WLAN enabled bridge or a short range communication enabled bridge.

10. A system of transferring at least one software file of at least one target node in a short range wireless network, the system comprises:
A transmitting module, wherein the transmitting module is enabled to transmit at least one advertising packet from an originating node, using a short range wireless communication link, to plurality of nodes of short range wireless network, situated in proximal range of the originating node, wherein the advertising packet comprises a network ID of the target node;
Retransmitting module, associate with each node of the short range communication network, wherein the retransmitting module retransmits the received advertising packet, using the short range wireless communication link, by the receiving node to either plurality of nodes, situated in proximal range to the receiving node, when the network ID of the target node, present in the advertising packet, does not matches with the network ID of the receiving node or back to the originating node via same route of nodes through which the advertising packet reaches the target node from the originating node, of the short range wireless network, when the network ID of the target node, present in the advertising packet, matches with the network ID of the receiving node; wherein the advertising packet received from the target node by the originating node comprises the network ID of each node, of the short range wireless network, through which the advertising packet reaches the target node from the originating node;
A computing module, wherein the computing module is enabled to compute a favorable route by the originating node, involving at least one node of the short range wireless network, to reach to the target node from the originating node, in order to transmit at least one data packet to the target node, wherein the data packet comprises the route information, in the short range wireless network, to reach to the target node and at least one software file of the target node; and
Data packet transmitting module, wherein the data packet transmitting module transmits at least one data packet to the target node from the originating node, in accordance with route information present in the data packet, wherein the target node extract the electronic files from the received data packet and perform at least one of store and install the extracted electronic files in a memory unit of the target node.

11. The system of claim 10, wherein the short range wireless communication network and short range wireless communication link is at least one of a Bluetooth network, near field communication network, ANT network, infrared communication network, WIBREE network, Zigbee network, Ultra-Wideband communication network, or any communication network implementing an Institute of Electrical and Electronics Engineers 802.15 standard.

12. The system of claim 10, wherein the software file is at least one of software files, dynamic link library files, shared object files, embedded software components, firmware files, executable files, data files, hex data files, system configuration files, and personal data files.

13. The system of claim 10, wherein the originating node is at least one of a computer application, mobile application, a tablet application or a wearable device application.

14. The system of claim 10, wherein the target node is at least one of an illumination device, a medical device, a wearable device, a tablet, server, a computer, a laptop or a home appliance device.

15. The system of claim 10, wherein the favorable route is the shortest distance route to reach to the target node from the originating node.

16. The system of claim 10, wherein the target node transmits the acknowledgement signal to the originating node after receiving the data packet.

17. The system of claim 10, wherein the memory unit of the target node is at least one of EEPROM, Flash memory, or an external memory.

18. The system of claim 10, wherein the at least one node, of short range network, is connected to the bridge which enables the inter-network communication between the originating node and the target node, wherein the bridge is at least one of internet enabled bridge, WIFI enabled bridge, LAN enabled bridge, WLAN enabled bridge or a short range communication enabled bridge.
